(19) United States
(12) Patent Application Publication
(10) Pub. No.: US 2025/0348514 A1
(43) Pub. Date: Nov. 13, 2025

(54) Programmatic Visualization of Database Tables

(71) Applicant: ServiceNow, Inc., Santa Clara, CA (US)

(72) Inventors: Sujit Sharma, Hyderabad (IN); Satish Kumar Kanikaram, Hyderabad (IN)

(21) Appl. No.: 18/662,104

(22) Filed: May 13, 2024

(51) Int. Cl. G06F 16/28; G06F 16/26

(52) U.S. Cl. CPC G06F 16/287; G06F 16/26; G06F 16/288

(57) ABSTRACT

Example embodiments may include obtaining an indication of a first portion of data, wherein the first portion of data is stored in a database, and identifying, based on metadata associated with the first portion of data, a second portion of data, wherein identifying the second portion of data comprises determining that the metadata indicates a hierarchical relationship between the first portion of data and the second portion of data. Example embodiments may additionally include obtaining, based on the first portion of data and the second portion of data, data from the database, and generating an output, wherein the output comprises an indication of: the obtained data and a schema-based representation of the hierarchical relationship.

### BACKGROUND

Managed networks can include a large number of devices and systems (e.g., hundreds, thousands, or more). These devices and systems may communicate with each other via complicated interdependencies and relationships. Additionally, databases may be used to manage configuration data for the network. However, determining relationships between portions of a network for which representations are stored and/or configured in a database and/or extracting information related to data or metadata from the databases may be time-consuming and prone to errors. Furthermore, visualizing interrelated portions of a database is challenging when relationships are difficult to determine accurately or efficiently. As a result, changes to configuration data may be difficult to identify and/or inefficient to perform.

### SUMMARY

Determining interdependencies and/or extracting portions of or information from a database for visualization can be challenging and/or inefficient. Computing resources are wasted as users perform trial-and-error searching and user interface navigation in attempts to piece together partial information into a comprehensive picture of the database's schema and/or structure.

Various implementations disclosed herein include systems and methods for determining and extracting portions of a database for visualization. More specifically, a starting point in the database (e.g., a table) may be identified based on an input (e.g., an application or plugin name). Based on the starting point or source, related portions or parts of the database may be determined. For example, if a table cataloging network servers is identified as a source, a related table could be a table of client devices connected to each of the servers. Data (e.g., the contents of a table) and/or metadata (e.g., header information for the table or relationships to other tables) may be extracted and reformatted into an output that may be parsed by a visualization tool. In some cases, relationships and interdependencies may be identified based on metadata associated with the database. By automatically extracting interrelated portions of the database and reformatting for use with a visualization tool, improved understanding and more efficient troubleshooting of the database may be possible. The programmatic visualization of database tables may result in a more robust method of visualization, more efficient and/or less-compute intensive analysis of a database or network, faster and more consistent changes to configuration data.

Accordingly, a first example embodiment may involve obtaining an indication of a first portion of data, wherein the first portion of data is stored in a database; identifying, based on metadata associated with the first portion of data, a second portion of data, wherein identifying the second portion of data comprises determining that the metadata indicates a hierarchical relationship between the first portion of data and the second portion of data; obtaining, based on the first portion of data and the second portion of data, data from the database; and generating an output, wherein the output comprises an indication of: the obtained data; and a schema-based representation of the hierarchical relationship.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 illustrates a schematic drawing of a database extraction engine, in accordance with example embodiments.

FIG. 7A depicts class definitions, in accordance with example embodiments.

FIG. 7B depicts output data, in accordance with example embodiments.

FIG. 7C depicts a graphic user interface, in accordance with example embodiments.

FIG. 8 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is the challenge of accurately and programmatically determining relationships in a database and identifying interrelated portions or information to extract for visualization. In practice, this is problematic because correctly identifying related portions of the database and formatting them for visualization can be time-consuming and prone to errors, leading to inefficiency (in terms of processor and memory utilization wasted through trial and error) and potentially inaccurate representations of a database.

In other techniques, methods utilized to determine interdependencies and to extract database information for visualization do not offer reliable or comprehensive approaches to handle complex database structures and relationships. Moreover, these techniques rely on the subjective decisions and experiences of database administrators or analysts, which leads to wildly varying outcomes from instance to instance. Thus, these techniques do little if anything to address the need for efficient and accurate extraction of data and/or metadata from a database for visualization of interdependencies or database structures.

The embodiments herein overcome these limitations by automatically identifying interrelated portions of the database and reformatting them for visualization purposes. By leveraging these techniques, this process becomes more efficient and less prone to errors. In this manner, the database structure and relationships can be visualized in a more accurate and robust fashion. This results in several advantages. First, it streamlines the process of database visualization, saving time and resources. Second, it enhances the accuracy and reliability of insights derived from the database. Third, it facilitates more efficient troubleshooting and analysis of the database, leading to decreases in system performance degradation and downtime when the database is being used to help identify root causes of network problems.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

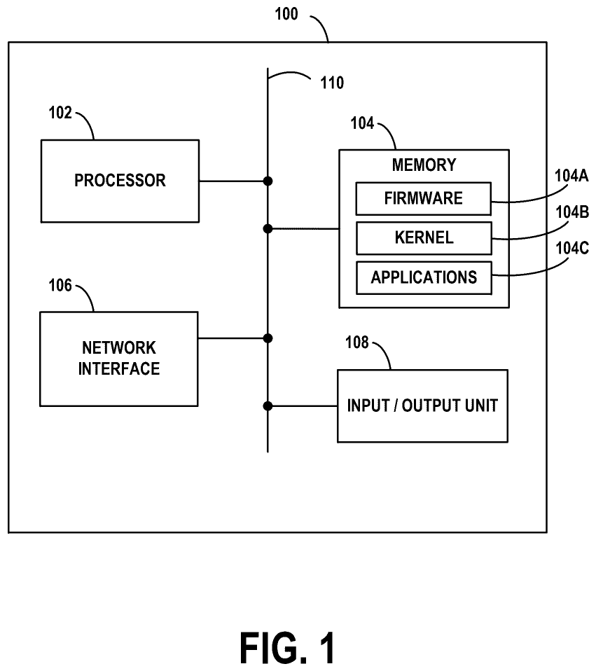

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

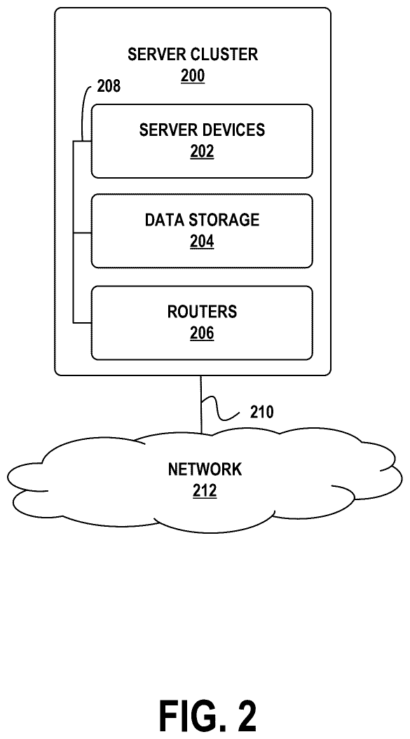

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

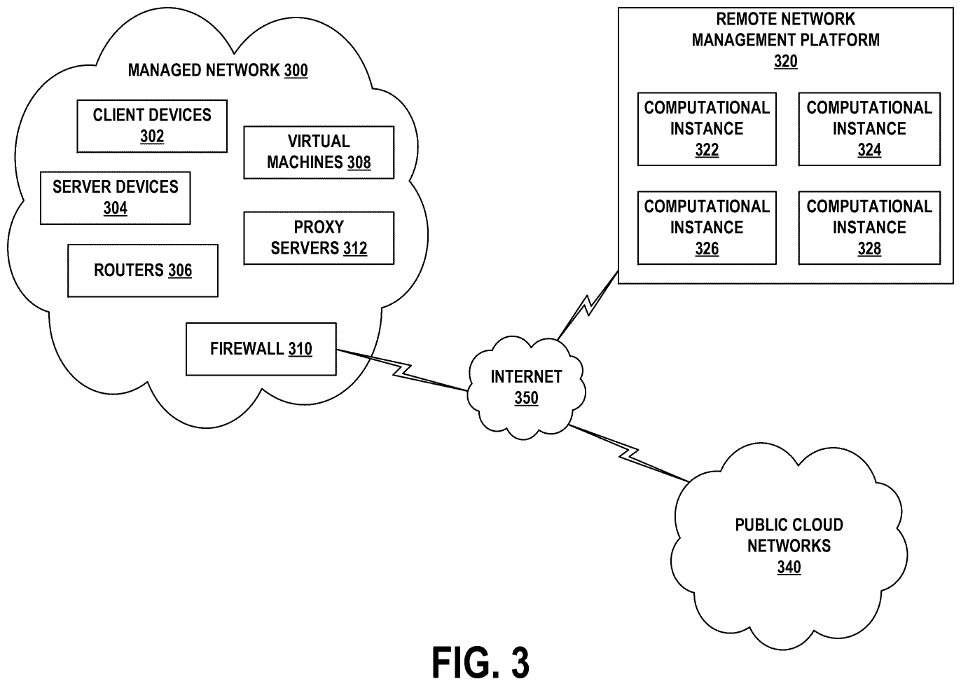

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

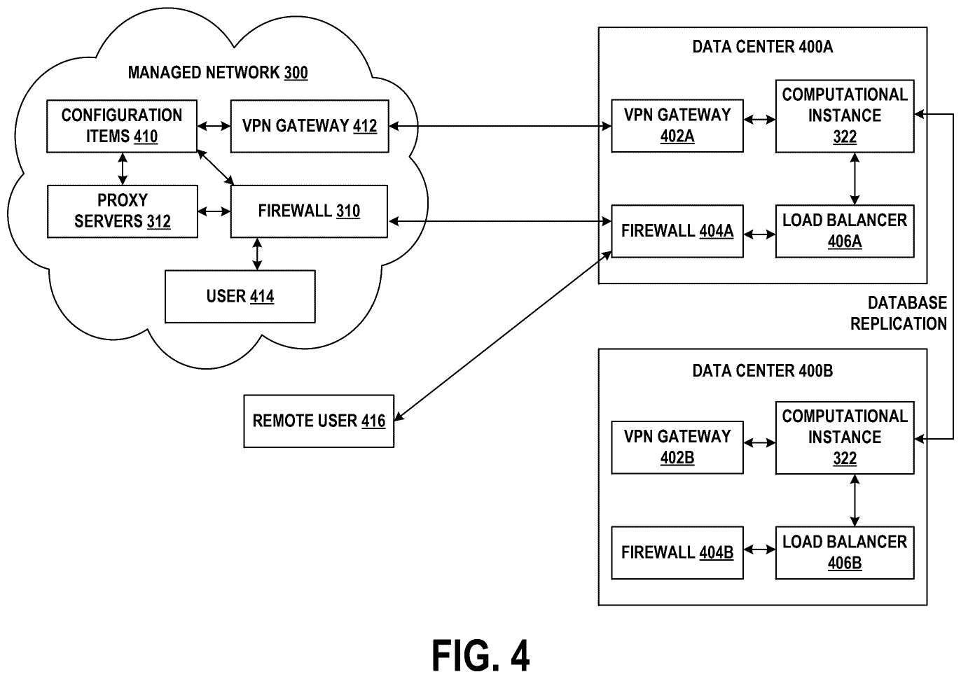

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

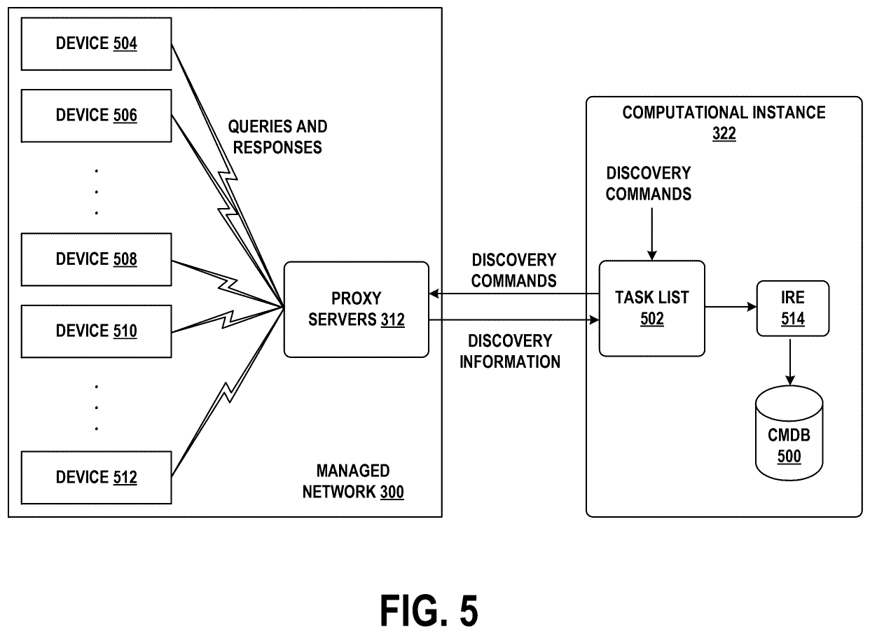

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Example Extraction of Data for Visualization

As discussed above, determining interdependencies and extracting related portions of a database for visualization is challenging and inefficient. Existing methods may fail to accurately handle complex structures, leading to varying outcomes and inefficiencies in terms of computing resource utilization.

In general, databases are structured collections of data that are organized and stored in a way that allows for efficient retrieval, management, and manipulation. Databases may serve as a central repository for storing and managing various types of information, such as text, numbers, images, multimedia files, configuration information, etc. Databases may enable other systems or users to perform tasks such as querying, updating, and analyzing information. In the context of managed networks, CMDB 500 of FIG. 5 is a database, and data stored in data storage 204 may be stored in a database.

There exist different types of databases, including relational databases, NoSQL databases, object-oriented databases, and graph databases, among other possibilities. Relational databases may use table schema to organize data into tables consisting of rows and columns, with each row representing a record and each column representing a field or attribute. Table schema may define or outline the structure of a database table by specifying the columns or fields that exist within the table, along with their data types, constraints, and any other relevant attributes. Relational databases may use structured query language (SQL) for querying and manipulating data. Some examples of relational databases include Microsoft SQL Server, Oracle Database, MySQL and IBM DB2. NoSQL databases may not adhere to a rigid tabular structure, and may be designed to handle unstructured or semi-structured data and offer flexible data models, improving scalability and high performance. Some examples of NoSQL databases include MongoDB, BigTable, Redis, Cassandra. Object-oriented databases may store data as objects, each containing data fields and methods, and may be used in object-oriented programming environments to persistently store and retrieve objects. In object-oriented databases, objects may be identified by metadata, i.e. a description of the object used to identify that object in the database. Graph databases may represent data as nodes, edges, and properties, and may be used to store and query highly interconnected data, such as social networks or network topologies. Other types of databases exist.

Information stored in databases may be represented with tables, which include collections of related data, where each row in a table corresponds to a single record, while each column represents a specific attribute or field of the data. Rows, also known as records or tuples, are individual entries within a table, each containing a set of values corresponding to the attributes defined by the table's columns. Each row may represent an instance of data. Columns can define the different types of data that can be stored in a table. Each column may have a name and associated data type, which determines the kind of information it can contain, such as text, numbers, dates, or binary data.

Tables or other collections of related data may include a primary key and a foreign key. A primary key may serve as a unique identifier for each record within a table or collection. Typically consisting of one or more columns, primary keys uniquely identify records and facilitate efficient data retrieval. A foreign key may establish relationships or connections between tables by referencing a primary key of another table. Foreign keys may be used to improve referential integrity (i.e., that data relationships are consistent and valid).

Metadata-based databases may structure and organize data primarily through metadata rather than through the traditional table or tabular structures found in relational databases. For example, as discussed above, in traditional relational databases, data is organized into tables consisting of rows and columns. In a metadata-based database, the structure and relationships between data elements may be defined and managed using metadata. This metadata provides information about the data, such as its type, format, relationships to other data elements, and constraints. Metadata-based databases may offer greater flexibility in terms of data modeling and organization. Since the structure of the data is defined through metadata, it may be more easily modified and adapted to changing requirements without the need to alter the underlying database schema metadata-based databases may also be able to handle more complex data structures and relationships compared to traditional relational databases. They may allow for hierarchical data structures, nested data elements, and multi-level relationships.

Data in one type of database may be ported and/or represented in another type of database and/or visualized. For example, entity-relationship diagrams (ERDs) may be used as visual representations of relationships between entities (or tables or collections of data) in a database. For instance, an ERD could represent entities as rectangles and relationships between entities as lines connected related entities. ERDs and other visualization tools may be helpful in performing analysis on data and/or metadata of a database, as well as enabling more rapid dissemination of changes or other operations to the database. Moreover, ERDs may assist in identifying potential design flaws, optimizing database performance, and guiding future database modifications.

As such, it may be helpful to visualize a portion of a database with an ERD. For example, an ERD for a portion of configuration data for a subset of configuration items in a managed network may include entities like “servers,” “client devices,” and “connections,” each with their respective attributes and relationships. For instance, the “servers” entity may include details such as server name, IP address, and operating system, while the “client devices” entity could encompass client devices such as computers or mobile phones, along with their respective configurations. The “connections” entity may represent relationships between servers and client devices, illustrating the network topology and dependencies between components. In general, configuration data may refer to any information related to the configuration of a system or an environment, and may encompass a broad range of data, including specifications, settings, parameters, and relationships between various elements within the system. Configuration items (CIs) may represent individual components or elements within a system that are subject to configuration management. These can be tangible items like hardware components (e.g., servers, routers) or intangible items like software modules, documentation, etc. Accordingly, unless otherwise indicated, configuration data encompasses and includes CIs.

It may be beneficial to visualize only a portion or subset of data within database. For example, in a managed network with hundreds or thousands of devices and systems, focusing a visualization on a sub-portion of a database may enable more rapid analysis and/or more efficient prioritization and allocation of resources. However, it may be challenging to identify and/or determine which portion or subset of a database is related to an entity. Returning to the above example, a user of a system may not know that the “servers” entity is related to the “client devices” entity by way of the “connections” entity. Thus, extracting or obtaining a subset or portion of related data from a database for visualization (e.g., with an ERD) may be a manual, inefficient and/or error-prone process.

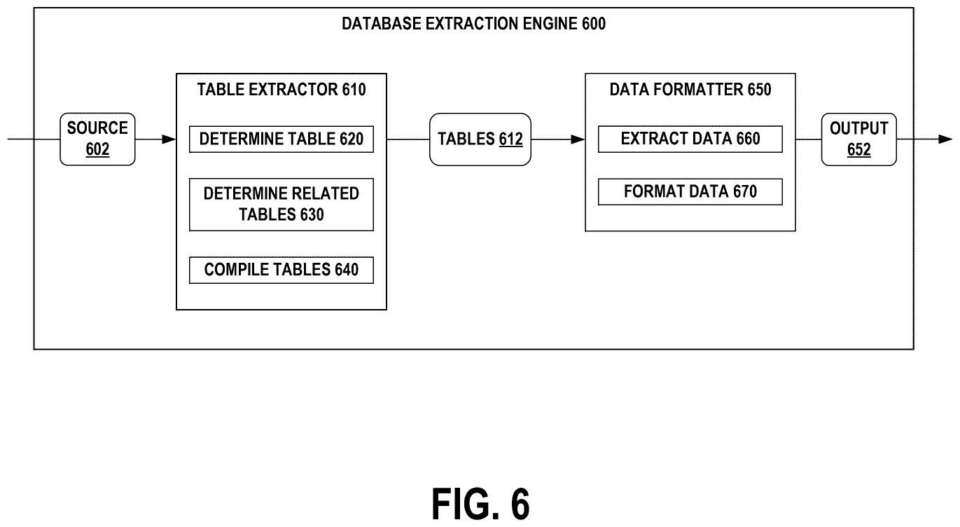

Accordingly, FIG. 6 illustrates a schematic drawing of database extraction engine 600 for programmatic visualization of database tables, in accordance with example embodiments. Herein, the term “engine” (e.g., database extraction engine 600) may refer to a features of a system or application that manages core functionality and processing. Thus, an engine may be considered to be, for example, a central part of a software application or the application as a whole. Database extraction engine 600 may include table extractor 610 and data formatter 650.

Table extractor 610 may be configured to obtain source 602. Source 602 may be a table, a representation of a table, a reference (e.g., a pointer) to a table, a name of a plugin, application, system, or device, among other possibilities. For example, source 602 may be a specific table in CMDB 500, as discussed in the context of FIG. 5. As another example, source 602 may be an application with access to a subset of data storage 204, as discussed in the context of FIGS. 2 and 3. Table extractor 610 may be configured to obtain source 602 through different means, for example, by receiving source 602 directly or by extracting source 602 (e.g., in response to a prompt or command). For example, a user could provide source 602 as an input parameter to database extraction engine 600. As another example, database extraction engine 600 may be configured to obtain source 602 from an application. In some cases, source 602 may also include an input and/or output format. For instance, source 602 could include an application name and an indication that the input is an application name. As another example, source 602 could include a parameter specifying a format for output 652.

Table extractor 610 may be configured to perform operations of block determine table 620. Block determine table 620 may include determining, based on source 602, one or more starting points (or “core table(s)”) in a database from which to extract data. Determining a core table could be done by way of schema analysis, heuristics or rules, user input or configuration, machine learning methods, among other possibilities. For example, if a user input includes “servers,” table extractor 610 may be configured to identify a table listing all of the servers in a network as a core table(s). As another example, if an application has access to a subset of tables or configuration items within the database, the core table(s) could include those tables to which the application has access.

Table extractor 610 may be configured to perform operations of block determine related tables 630. Block determine related tables 630 may include determining, based on the core table, one or more related tables. Unless otherwise indicated, the term “related tables” may refer to any other portions of related data and/or information from the database, even if the database does not implicitly or explicitly represent data in a traditional table (e.g., with rows and columns). The related tables could be parent tables, child tables, related by other dependencies (e.g., where the core table(s) is a subset of a related table), share rows, columns, attributes, among other possibilities. As an example, if a core table(s) represents servers, a table representing all devices in a network could be a parent table, as servers are a subset of all devices. As another example, if two tables have a common column representing a unique identifier, they may be considered related.

In some cases, related tables may be determined based on metadata associated with core table(s) and/or with related tables. Metadata could include descriptions of tables, row or column names and/or associated data types, constraints, indexing information, and/or system catalogs or data dictionaries. In some cases, related tables may be determined based on primary and/or foreign keys. For example, relationships between tables may be inferred from primary and foreign key constraints defined in the database schema. Tables that have foreign keys referencing the primary key of the core table(s) or vice versa are likely related. In some cases, related tables may be determined based on inheritance hierarchies of the core table(s). For example, if there are multiple nested tables, some or all of the sub-tables may be identified as related tables. In some cases, related tables may be determined based on user input and/or obtained from another input, e.g., from an application or computing system.

Table extractor 610 may be configured to perform operations of block compile tables 640. Block compile tables 640 may include aggregating a list, set, repository, or other representation of the core table(s) and some or all of the related tables into tables 612. Compiling tables 612 may include checking and/or removing duplicate tables or redundant information. Compiling tables 612 may include exporting information from the database (e.g., storing in another repository) and/or storing a reference to the tables (e.g., compiling a list of pointers). Other implicit or explicit compilations of tables are also possible.

Data formatter 650 may be configured to obtain tables 612 and perform operations of block extract data 660. Block extract data 660 may include querying tables to extract data and/or metadata associated with tables 612. Data (including metadata) may be extracted from tables 612 through one or more methods, including SQL queries, database management tools, scripts, APIs, etc. Returning to the example of servers, client devices, and connections, data extracted could include a list of servers contained in the servers table, metadata indicating how the servers table relates to the client devices table, and a list of client devices contained in the client devices table. The data extracted may be formatted in a variety of ways, for example comma-separated value (CSV) files, spreadsheets (e.g., Excel), JSON files, XML files, SQL scripts, text, among other possibilities. There may be a default format for data extraction and/or there may be different formats based on performance and efficiency considerations.

Data formatter 650 may be configured to perform operations of block format data 670. Block format data 670 may include formatting, reformatting, augmenting, adjusting, and/or modifying data extracted from tables 612, among other possibilities. For example, these operations could involve ensuring consistent data types, formats, and structures across the data. In some cases, reformatting may involve transforming the data from one format to another, such as converting date formats or standardizing numerical values. As another example, adjusting the data may include making modifications to improve its quality, consistency, or usability, such as correcting errors, removing duplicates, or normalizing data values.

Output 652 may be generated by data formatter 650, and may be formatted in a variety of ways, as discussed above. Output 652 may include data extracted (e.g., values in rows of a table) and/or metadata associated with the data (e.g., representations of relationships between tables, indications of hierarchies or interdependencies within the data, etc.).

In some cases, the operations of block format data 670 may include formatting extracted data into output 652 that may be parsed and/or used by a visualization tool (e.g., to generate a display or representation). In some cases, the output 652 may be formatted or configured to be used by a visualization tool to generate a visualization, such as an ERD. Example visualization tools include Lucidchart, draw.io, dbdiagram, Tableau, Power BI, Qlik View, and Google Data Studio, among other possibilities. Different visualization tools may have different requirements or input configurations. For example, Lucidchart may use a CSV or JSON format with specific columns, attributes, elements, or characteristics to generate visualizations.

Accordingly, formatting the data extracted from tables 612 may include configuring output 652 to comply with the requirements of one or more particular visualization tools. These operations may include adding default values to, for example, a CSV file to avoid it having invalid content, adding column identification information, modifying value types (e.g., from an integer to a string), specifying a primary and/or foreign key, indicating reference types (e.g., one: one, one: many, many: many), etc. In some cases, a particular output format may be obtained and output 652 configured accordingly. For example, source 602 could include a user input indicating that output 652 should be formatted for use with draw.io. As another example, database extraction engine 600 could prompt a user to enter a desired output format and/or specify formatting requirements.

In some cases, output 652 may be used as input to such a visualization tool to generate a visualization representing some or all of the data extracted (e.g., representing a portion of the database). A visualization, such as a chart, graph, diagram, or dashboard could be displayed (e.g., on a GUI). In some cases, the visualization may focus on or highlight specific subsets or aspects of the data.

Table extractor 610 and/or data formatter 650 may be configured to perform the operations of blocks determine table 620, determine related tables 630, compile tables 640, extract data 660, and/or format data 670 by way of a recursive algorithm. For example, if the core table(s) has a child table that depends on it and a parent table from which it depends, a recursive algorithm could extract data and/or metadata from the core table(s), then query the child table to extract its data and/or metadata, including whether the child table has one or more of its own child tables (“grandchild” tables of the core table(s)). The grandchild tables could then be queried to determine further relationships and/or to extract and format data represented by them. Similarly, the parent of the core table(s) could be queried to determine further relationships and/or to extract and format data represented by it, including whether the parent table has other child tables (“sibling” tables of the core table(s)). The sibling tables could similarly be queried. This process may repeat until tables are determined and/or had data extracted from some or all levels of nesting or hierarchies. In some cases, the recursive algorithm may have a stopping condition (e.g., a maximum level of nesting). Other algorithms for table determination and data extraction and/or formatting are possible. For instance, iterative algorithms may be used.

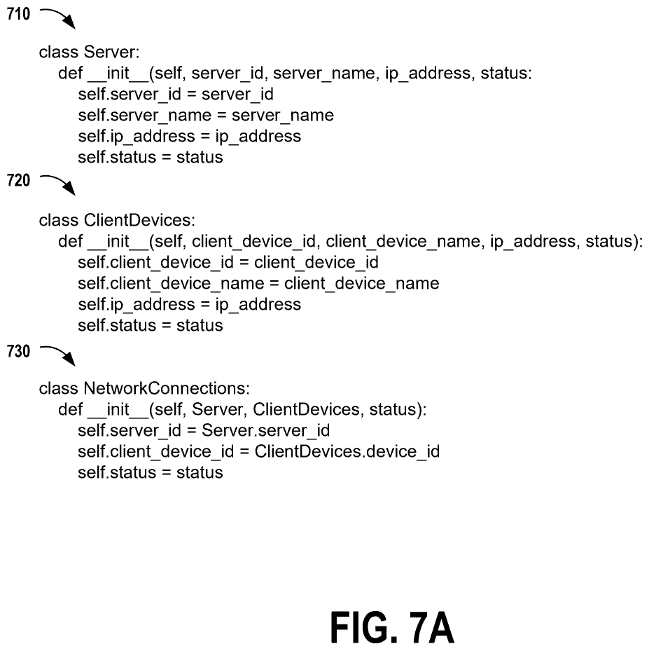

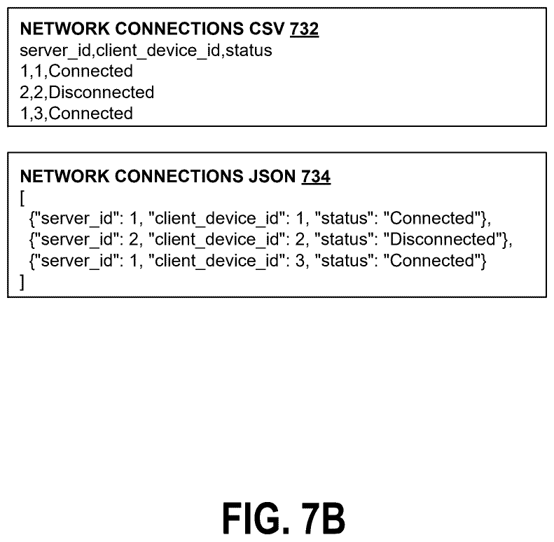

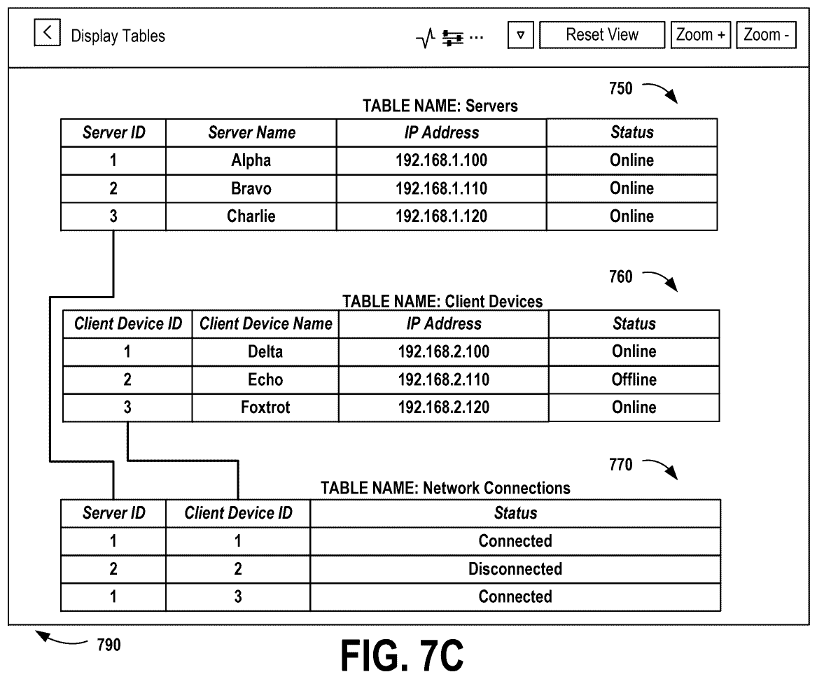

FIGS. 7A, 7B, and 7C depict the above-described example with servers, client devices, and connections. Each server may be connected to one or more client devices. For example, a server could connect to a personal computer and a mobile phone. Additionally, each server to client device connection may have a status associated with it. For instance, a server could be connected to the personal computer and disconnected to the mobile phone (if, for example, the mobile phone is turned off). Accordingly, a database managing configuration data for servers, client devices, and connection may include information about each server, information about each client device, and information about each connection therebetween.

FIG. 7A depicts an example object-oriented representation of metadata for a database. Block 710 depicts a definition of a “server” class, which contains a server_id, a server_name, an ip_address, and a status. The server_id could represent a primary key. Block 720 depicts a definition of a “clientdevices” class, which contains a client_device_id, a client_device_name, an ip_address, and a status. The device_id could represent a primary key. Block 730 depicts a definition of a “network connections” class, which contains a server_id, a client_device_id, and a status. The server_id and client_device_id could represent foreign keys, as they relate to the server and client devices classes. In the context of FIG. 6, these class definitions could represent metadata and/or be included in tables 612.

FIG. 7B depicts two different example outputs representing data from the “network connections” entity. In the context of FIG. 6, each of these representations could independently or jointly be included in output 652. Network connections CSV 732 represents data in network connections in a CSV format, where values are separated by commas. Network connections JSON 734 represents data in Network connections in a JSON format. Similar outputs could be generated for other entities in the database (e.g., the server entity and/or the client devices entity). In the context of FIG. 7B, both example outputs indicate that the server_id 1 and the client_device_id 1 are connected, that the server_id 2 and the client_device_id 2 are disconnected, and that the server_id 1 and the client device_id 3 are connected.

FIG. 7C depicts an example visualization on a GUI 790 that could be generated based on output, such as output 652 in the context of FIG. 6. For instance, network connections CSV 732 from FIG. 7B could be used to generate network connections table 770. Likewise, servers table 750 and client devices table 760 could be generated from similar outputs representing data in each of them. As is shown in FIG. 7C, a visualization may include data for each entity (e.g., status information in network connections table 770), as well as representations of relationships between entities (e.g., connectors between the server ID of servers table 750 and the server ID of network connections table 770). The relationship data may be provided as metadata (e.g., the blocks from FIG. 7A). As discussed above, the network connections table 770 indicates that the server_id 1 and the client_device_id 1 are connected, that the server_id 2 and the client_device_id 2 are disconnected, and that the server_id 1 and the client device_id 3 are connected. The client devices table 760 indicates that client_device_id 2 is offline, suggesting that the client device might be turned off or otherwise unable to connect to the internet.

The tables of FIG. 7C may provide an interpretable visualization of a portion of a database, including data for each entity and how different entities within the database are dependent and/or related to one another. By providing methods and systems for programmatic extraction of data from a database and/or formatting of data for visualization, embodiments disclosed herein may improve database visualization, saving time and resources and facilitating efficient troubleshooting. For example, by visualizing the relationship between the client devices table 760 and the network connections table 770, it may be more efficient to determine that the status of the connection from server_id 2 to client_device_id 2 as disconnected is related to the status of client_device_id 2 as offline. Accordingly, it may be easier to determine root causes and/or identify possible solutions, such as restarting or powering on client_device_id 2 to remedy the connection between server_id 2 and client_device_id 2.

### VIII. Example Operations

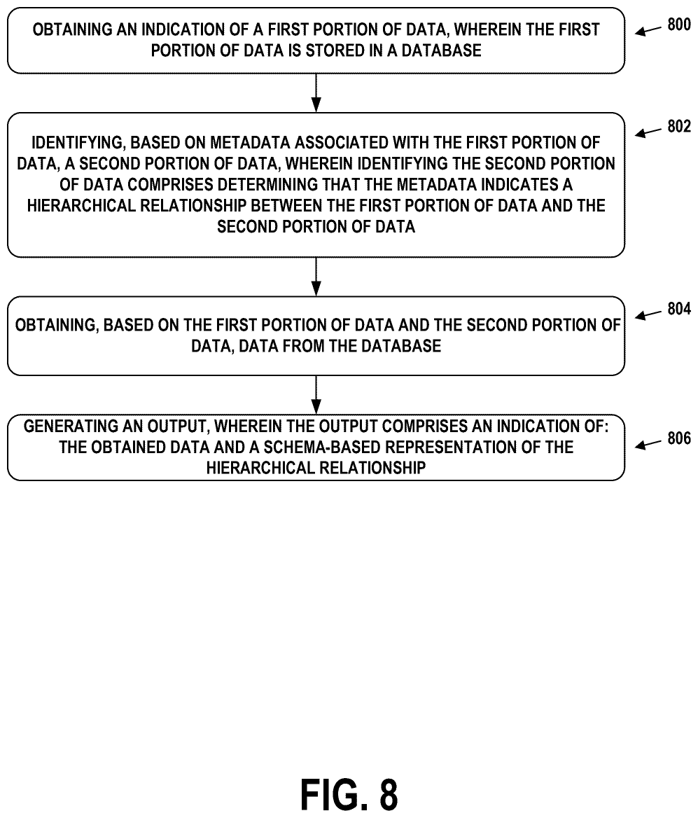

FIG. 8 is a flow chart illustrating an example embodiment. The process illustrated by FIG. 8 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 8 may be simplified by the removal of any one or more of the features shown therein. Further, these embodiments may be combined with features, aspects, and/or implementations of any of the previous figures or otherwise described herein.

Block 800 may include obtaining an indication of a first portion of data, where the first portion of data is stored in a database.

Block 802 may include identifying, based on metadata associated with the first portion of data, a second portion of data. Identifying the second portion of data may include determining that the metadata indicates a hierarchical relationship between the first portion of data and the second portion of data. The programmatic identification of interrelated portions of data based on associated metadata may enable a more accurate and robust assessment of how data (e.g., in the database) is related to other data, especially if there are complex hierarchical relationships.

Block 804 may include obtaining, based on the first portion of data and the second portion of data, data from the database. By identifying portions or subsections of data in the database to obtain, computational resources may be used more efficiently (than, for example, extracting an entire dataset from a database if only a portion would be sufficient), and data may be obtained more quickly.

Block 806 may include generating an output. The output may include an indication of: the obtained data and a schema-based representation of the hierarchical relationship. A schema-based representation may facilitate more efficient troubleshooting and analysis of the database, leading to decreases in system performance degradation and downtime if, for example, the database is being used to help identify root causes of network problems.

In some embodiments, the database is configured to store data in an object-oriented representation.

In some further embodiments, the first portion of data and the metadata are stored in the object-oriented representation.

In some embodiments, the second portion of data is stored in the database.

In some further embodiments, the data from the database includes the first portion of data and the second portion of data.

In some embodiments, determining that the metadata indicates the hierarchical relationship include parsing the metadata to obtain a reference from the first portion of data to the second portion of data, where the metadata includes the reference.

In some embodiments, identifying the second portion of data is performed by way of recursion.

In some further embodiments, the recursion includes parsing the metadata to obtain a first reference from the first portion of data to the second portion of data, obtaining, from the first reference, second metadata associated with the second portion of data, and parsing the second metadata to obtain a second reference from the second portion of data to a third portion of data. The data in the database includes at least part of the first portion of data, the second portion of data, or the third portion of data.

In some embodiments, the recursion further includes performing a stopping condition, where the stopping condition includes a limit on a number of references from a portion of data to another portion of data and terminating, based on the stopping condition, the recursion. The data from the database includes at least the portion of data.

In some embodiments, the recursion further includes performing a checking condition, where the checking condition includes a check that the first portion of data differs from the third portion of data. The data from the database includes the first portion of data and the third portion of data.

In some embodiments, obtaining the data from the database includes parsing the metadata to determine a part of the first portion of the data and a part of the second portion of the data that form part of the hierarchical relationship and extracting the part of the first portion of the data and the part of the second portion of the data from the database.

In some embodiments, the output corresponds to a visualization that comprises: the obtained data and the schema-based representation of the hierarchical relationship.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media like register memory, processor cache, RAM, ROM, optical or magnetic disks, solid-state drives, or compact disc read only memory (CD-ROM), for example. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

1. A method for programmatic visualization of database tables, the method comprising:
obtaining, by a database extraction engine via a graphical user interface, an indication of a first portion of data, wherein the first portion of data is stored in a database, wherein the first portion of data is a core table;
automatically identifying, by the database extraction engine based on metadata associated with the first portion of data, a second portion of data, wherein identifying the second portion of data comprises determining that the metadata indicates a hierarchical relationship between the first portion of data and the second portion of data, wherein the second portion of data is a related table;
obtaining, by the database extraction engine based on the first portion of data and the second portion of data, data from the database; and
generating, by the database extraction engine for display on the graphical user interface, a visualization of the obtained data in accordance with a schema-based representation of the hierarchical relationship.

2. The method of claim 1, wherein the database is configured to store data in an object-oriented representation.

3. The method of claim 2, wherein the first portion of data and the metadata are stored in the object-oriented representation.

4. The method of claim 1, wherein the second portion of data is stored in the database.

5. The method of claim 4, wherein the data from the database comprises the first portion of data and the second portion of data.

6. The method of claim 1, wherein determining that the metadata indicates the hierarchical relationship comprises:
parsing the metadata to obtain a reference from the first portion of data to the second portion of data, wherein the metadata comprises the reference.

7. The method of claim 1, wherein identifying the second portion of data is performed by way of recursion.

8. The method of claim 7, wherein the recursion comprises:
parsing the metadata to obtain a first reference from the first portion of data to the second portion of data;
obtaining, from the first reference, second metadata associated with the second portion of data; and
parsing the second metadata to obtain a second reference from the second portion of data to a third portion of data, wherein the data in the database comprises at least part of the first portion of data, the second portion of data, or the third portion of data.

9. The method of claim 8, wherein the recursion further comprises:
performing a stopping condition, wherein the stopping condition comprises a limit on a number of references from a portion of data to another portion of data; and
terminating, based on the stopping condition, the recursion,
wherein the data from the database comprises at least the portion of data.

10. The method of claim 8, wherein the recursion further comprises:
performing a checking condition, wherein the checking condition comprises a check that the first portion of data differs from the third portion of data,
wherein the data from the database comprises the first portion of data and the third portion of data.

11. The method of claim 1, wherein obtaining the data from the database comprises:
parsing the metadata to determine a part of the first portion of the data and a part of the second portion of the data that form part of the hierarchical relationship; and
extracting the part of the first portion of the data and the part of the second portion of the data from the database.

12. (canceled)

13. A non-transitory computer-readable medium, having stored thereon program instructions for programmatic visualization of database tables that, upon execution by a computing system, cause the computing system to perform operations comprising:
obtaining, by a database extraction engine via a graphical user interface, an indication of a first portion of data, wherein the first portion of data is stored in a database, wherein the first portion of data is a core table;
automatically identifying, by the database extraction engine based on metadata associated with the first portion of data, a second portion of data, wherein identifying the second portion of data comprises determining that the metadata indicates a hierarchical relationship between the first portion of data and the second portion of data, wherein the second portion of data is a related table;
obtaining, by the database extraction engine based on the first portion of data and the second portion of data, data from the database; and
generating, by the database extraction engine for display on the graphical user interface, a visualization of the obtained data in accordance with a schema-based representation of the hierarchical relationship.

14. The non-transitory computer-readable medium of claim 13, wherein the database is configured to store data in an object-oriented representation.

15. The non-transitory computer-readable medium of claim 13, wherein the second portion of data is stored in the database.

16. The non-transitory computer-readable medium of claim 13, wherein determining that the metadata indicates the hierarchical relationship comprises:
parsing the metadata to obtain a reference from the first portion of data to the second portion of data, wherein the metadata comprises the reference.

17. The non-transitory computer-readable medium of claim 13, wherein identifying the second portion of data is performed by way of recursion.

18. The non-transitory computer-readable medium of claim 17, wherein the recursion comprises:
parsing the metadata to obtain a first reference from the first portion of data to the second portion of data;
obtaining, from the first reference, second metadata associated with the second portion of data; and
parsing the second metadata to obtain a second reference from the second portion of data to a third portion of data, wherein the data in the database comprises at least part of the first portion of data, the second portion of data, or the third portion of data.

19. The non-transitory computer-readable medium of claim 13, wherein obtaining the data from the database comprises:
parsing the metadata to determine a part of the first portion of the data and a part of the second portion of the data that form part of the hierarchical relationship; and
extracting the part of the first portion of the data and the part of the second portion of the data from the database.

20. A system for programmatic visualization of database tables comprising:
one or more processors; and
memory, containing program instructions that, upon execution by the one or more processors, cause the system to perform operations comprising:
obtaining, by a database extraction engine via a graphical user interface, an indication of a first portion of data, wherein the first portion of data is stored in a database, wherein the first portion of data is a core table;
automatically identifying, by the database extraction engine based on metadata associated with the first portion of data, a second portion of data, wherein identifying the second portion of data comprises determining that the metadata indicates a hierarchical relationship between the first portion of data and the second portion of data, wherein the second portion of data is a related table;
obtaining, by the database extraction engine based on the first portion of data and the second portion of data, data from the database; and
generating, by the database extraction engine for display on the graphical user interface, a visualization of the obtained data in accordance with a schema-based representation of the hierarchical relationship.

21. The method of claim 1, wherein the method is for programmatic visualization of database tables for improved network problem resolution, wherein the core table is associated with entities in a network, wherein the related table is associated with connection status in the network, wherein the hierarchical relationship is between the entities in the network and the connection status in the network.
